(19) United States
(12) Patent Application Publication
(10) Pub. No.: US 2007/0227795 A1
(43) Pub. Date: Oct. 4, 2007

(54) Operating and Display Unit

(75) Inventors: Manfred Dorn, Stuttgart (DE); Volker Hellwig, Stuttgart (DE); Gerhard Seidel, Ostfildern (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/572,657

(22) PCT Filed: Sep. 2, 2004
(86) PCT No.: PCT/EP04/09759

§ 371 Date: Mar. 13, 2007

(30) Foreign Application Priority Data
Sep. 18, 2003 (DE) 103 43 134.9

(51) Int. Cl. B60K 37/06

(52) U.S. Cl. 180/90

(57) ABSTRACT

An operating and display unit (1) for switching devices in a motor vehicle having at least one operating element and having a symbol display field (3′, 5′, 7′, 9′, 11′) which is associated with the operating element (3, 5, 7, 9, 11), is arranged in a fixed manner at a geometrically determined point in relation to the operating element (3, 5, 7, 9, 11), and has the purpose of displaying a symbol which is assigned to the device to be switched. The operating and display unit (1) is distinguished by the fact that the symbol display field (3′, 5′, 7′, 9′, 11′) is embodied using black panel technology.

### BACKGROUND AND SUMMARY OF THE INVENTION

The invention relates to an operating and display unit for switching devices in a motor vehicle.

German Patent document DE 27 23 692 B2 discloses a generic operating and display unit which comprises an operating element for switching a device, and a plurality of symbol display fields which are assigned to the operating element and have the purpose of displaying in each case one symbol which is assigned to this device. The symbols indicate different switched states of the device. The symbol display fields are arranged offset laterally with respect to the operating element which is formed by a switching lever. The fields are designed so as to be capable of being illuminated. A plurality of switched states of the device can be selected by adjusting the switching lever, for example in the case of a lighting device the functions “OFF”, “parking light” and “dipped headlights”. Depending on the switched position of the switching lever, in each case one of the symbols represented in the symbol display fields is illuminated and, as a result, indicates the instantaneous switched state to the vehicle occupant. The known operating and display unit has the disadvantage that it takes up a relatively large area within the passenger compartment of the vehicle, which area is not available in all cases, at least in exposed locations in the field of vision of the driver of the vehicle, owing to the large number of manually switchable devices in a motor vehicle and the corresponding high number of operating elements and symbol display fields.

German Patent document DE 32 35 752 C2 discloses a multi-function pushbutton key which serves to switch a device, the multi-function pushbutton having more than two switched states which are each indicated by one light symbol. The light symbols being integrated into the multi-function pushbutton key. The multi-function pushbutton key has the disadvantage that it has to be made relatively large in order to be able to display symbols of a customary size. Owing to the contrast problem with the symbols, there is no free selection of colors and materials for the multi-functional key.

German Patent document DE 197 35 977 C2 discloses an operating and display unit with a plurality of operating elements which are each provided with a symbol display field and which are each assigned to a separate device, for example, an air conditioning system and a seat heating system. The operating elements are assigned a common setting element with an integrated display, which is used to adjust the functionality of the respectively active operating element.

An object of the invention is to provide an alternative to the known operating and display units.

In order to achieve the object, an operating and display unit of the present invention is distinguished by the fact that the symbol display field is embodied using black panel technology. It is advantageous that, in addition to achieving desired optics, there is the possibility of easily adapting the display to different devices or switched states.

In one preferred embodiment there the symbol display field is capable of being backlit in one or more colors by means of search lighting and/or functional lighting.

According to one embodiment variant, the symbol display field is embodied in such a way that it has a uniformly dark appearance in the state when there is no backlighting. The representation plane of the display, that is, the at least one symbol, can be seen exclusively when the lighting is switched on, while the front side—facing the vehicle occupant—of the symbol display field appears as an essentially dark, in particular black or dark gray surface when the lighting system is not switched on. The design of such symbol display fields for generating a black panel effect is generally known, for example from German Patent document DE 199 35 386 A1, so that more details will not be provided.

The black panel display provides, inter alia, the following representation possibilities which, as far as possible, can also be combined with one another:
1) the at least one symbol which is displayed in the symbol display field can be backlit by means of search lighting and/or functional lighting, a first functional state of the device being indicated when the symbol is backlit, and a second functional state of the device being indicated when the symbol is not backlit;
2) the functional state of the device which can be switched by actuating the operating element can be indicated by a change of color of the lighting which is backlighting the symbols;
3) various functional states of the device can be indicated by overlaying and deleting various symbols which are assigned to this device in one and the same symbol display field, for example “door open”/“door closed”;
4) when there is a multiple allocation of the operating element to functions for different devices, device-specific symbols can be displayed as a function of the instantaneously selected allocation of the operating element with, at least the symbol/symbols of the device which cannot currently be switched by means of the operating element being deleted (disappearance effect).

In one advantageous exemplary embodiment of the operating and display unit, a plurality of symbols can be displayed simultaneously or successively in the symbol display field. Because of this configuration, the number of symbol display fields can be reduced compared to the known operating and display units, which permits the space required within the motor vehicle for the individual components, in particular operating elements and symbol display fields, to be reduced. Furthermore, the reduced number of symbol display fields results in improved clarity, and thus, under certain circumstances, to better perception of the symbols displayed in the symbol display fields. In addition, the information about the switched state/functional state of the device can also be displayed clearly to the viewer without backlighting/lighting of the symbol or symbols which are being displayed.

The local separation of operator control (operating element) and display (symbol display field) provides a large number of degrees of freedom in the configuration of the operating element, and new possibilities in terms of display logic. The at least one operating element of the operating and display unit can be free of symbols of any type, and if appropriate, also free of search lighting and functional lighting so that there is virtually a free selection of material for the operating element, which, for example, may be composed of solid real metal, that is to say of a solid metal material, in particular aluminum or an aluminum alloy, wood or stone.

In order to achieve a desired visual effect and/or improved haptics, the operating element may be provided with a structure on at least its visible side, which is also the side with which an operator's hand comes into contact in order to actuate the operating element. If the structure is provided only for aesthetic reasons, the surface of the operating element may be of smooth design, while the surface has correspondingly different degrees of roughness at least in certain sections in order to produce a specific haptic. The structure can also be embodied in such a way that the operating element appears visually smaller than it actually is.

In conjunction with the invention here, the term “symbol” is understood to mean both symbols and individual letters, letter combinations, individual numbers or number combinations, in each case also in combination with one another.

The term “device” is intended to refer to virtually all electrical or electronic apparatuses and equipment which can be actuated, are present in the vehicle and whose manual switchability is required/desired, for example all external and internal lighting systems, window lifter (motors), central locking system, seat heating and ventilating system or systems, heating and/or air conditioning system, seat adjustment motors, window heating systems and the like.

Furthermore, an exemplary embodiment of the operating and display unit is preferred wherein the operating element and the assigned symbol display field are arranged next to each other or on top of one other without gaps, providing a visual association of the symbol display field and operating element.

An exemplary embodiment of the operating and display unit which comprises a plurality of operating elements with a respectively associated symbol display field is also preferred, the operating elements and symbol display fields being arranged in a virtual matrix which has—preferably right-angled—lines and columns. The symbol display fields and operating elements are each arranged in one or more rows or columns, in which case the functional assignment of an operating element to a symbol display field can be implemented by arranging them directly adjacent to one another.

Finally, an exemplary embodiment of the operating and display unit is distinguished by a switch-over device for optionally allocating to the operating element a function which is assigned to a specific device, the function being selectable from a number of functions of a plurality of devices, and in each case the at least one symbol, which is assigned to the function determined by the selection of the allocation of the operating element, is displayed in the symbol display field. Because of this configuration, the number of necessary symbol display fields and operating elements compared to the number of devices to be switched is reduced. As a result, the clarity of the symbol display fields, which are present and which are preferably arranged at exposed locations in the passenger compartment of the vehicle, is improved.

### BRIEF DESCRIPTION OF THE DRAWINGS

The invention will be explained in more detail below with reference to the drawing, in which:

FIG. 1 shows a detail of an exemplary embodiment of the operating and display unit according to the invention, specifically a plurality of operating elements and their assigned symbol display fields, in each case in a first switched state,

FIG. 2 shows the operating and display unit according to FIG. 1 in a second switched state, and

FIG. 3 shows a cross section through an exemplary embodiment of a symbol display field.

### DETAILED DESCRIPTION OF THE DRAWINGS

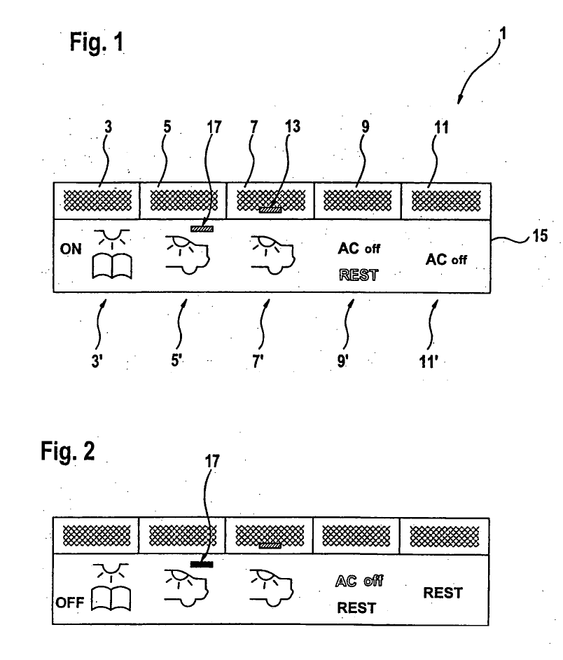

FIG. 1 shows a detail of an exemplary embodiment of an operating and display unit 1 for switching a plurality of devices in a motor vehicle. The operating and display unit 1 comprises a number of operating elements for manual actuation by an operator (vehicle occupant) and symbol display fields for displaying in each case at least one symbol which displays the switched state of the respective device, if appropriate by lighting. FIG. 1 illustrates only operating elements 3, 5, 7, 9 and 11 and the symbol display field 3′, 5′, 7′, 9′ and 11′ which are respectively assigned to the operating elements. The operating elements 3 to 11 are formed here by pushbutton keys, preferably rocker keys, which are provided on their front side with a structure which is formed by diamond-shaped ribbing, in order to improve the haptics. The structuring is not restricted to this exemplary embodiment but may be of virtually any desired design. The operating elements 3 to 11 are of identical size and form in this exemplary embodiment and are composed of a nontransparent material, for example aluminum. With the exception of the operating element 7, all the operating elements have a closed front side, that is to say one which is free of breakthroughs and openings.

The operating element 7 is provided with a breakthrough 13 which can be backlit by means of a lighting device (not illustrated) or into which a lighting means, for example a LED, is inserted and as a result of which a switched state of the device which is assigned to this operating element can be indicated by means of a light signal.

The operating elements 3 to 11 have a neutral appearance, that is to say without the symbol displayed in the respectively assigned symbol display field it is not possible to determine which operating element is assigned to which device. Owing to this configuration, the number of variants of the operating elements is reduced compared to known operating and display units, which gives cost advantages.

The operating elements 3, 5, 7, 9 and 11 are arranged in series, respectively adjacent operating elements being arranged one next to the other without gaps. This gives the visual effect of a continuous bar/panel.

The symbol display fields 3′, 5′, 7′, 9′ and 11′ are arranged directly, that is to say without gaps, under the operating elements 3 to 11 and are embodied using black panel technology. This means that the symbol display fields 3′ to 11′ are arranged behind a dark front panel 15 which can be backlit, the symbols located in the symbol display fields only being perceptible in the display plane when the lighting, which is located behind the front panel 15, is switched on, while, on the other hand, the surface of the front panel 15 appears dark when the lighting is switched off.

From FIG. 1 it is readily apparent that the face of the projected front side of the operating elements 3 to 11 is significantly smaller than that of the symbol display fields, which can be implemented by virtue of the fact that no symbols, which have to have a certain minimum size in order to be perceived satisfactorily, are provided on the operating elements 3 to 11. The height of the operating elements is more than half smaller than that of the symbol display fields.

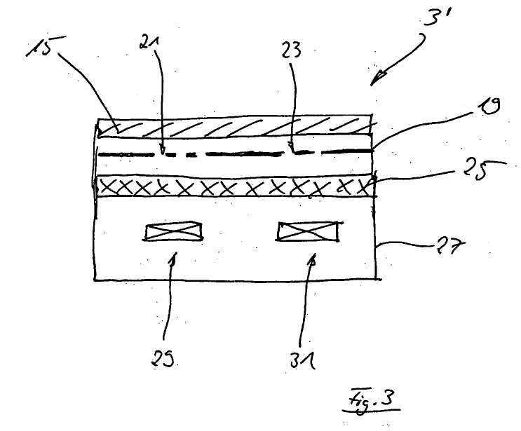

The operating element 3 has the purpose of switching a reading light on and off, which light is represented in the symbol display field 3′ by the “lamp and book” symbol. The two switched states of the reading light are indicated in the symbol display field 3′ by the terms “ON” (FIG. 1) and “OFF” (FIG. 2). As is apparent from FIGS. 1 and 2, the symbol display field 3′ is embodied in such a way that the symbols “ON” and “OFF” are displayed at different locations within the symbol display field 3′, it being possible to perceive just one of these symbols depending on the switched state of the reading light, while the other symbol is deleted (disappearance effect). It is to be noted that apart from the symbol display field 3′ other symbol display fields can also be embodied in such a way that various symbols can be overlaid behind the black panel (front panel 15) and deleted.

The operating element 5 is used to switch on and off a rear-space lighting device which is represented in the symbol display field 5′ by the graphic of a vehicle rear area with a lamp in the roof area. The two switched states (on/off) of the rear-space lighting device are indicated in the symbol display field 5′ by a light symbol which is provided next to the graphic in a field 17 which is integrated into the symbol display field 5′, in which case, for example, the illuminated field 17 (FIG. 2) signals the switched-on state of the rear-space lighting device. There is provision for the color of the graphics to remain unchanged, that is to say for example white, in the symbol display field 5′ in both switched states.

In order to implement a colored display of the various switched states, there is also provision, as an alternative to the exemplary embodiment specified above, for the graphic/symbol to be backlit in color so that it is possible to dispense with the field 17.

The operating element 7 and the assigned symbol display field 7′ correspond in their function to the operating element 5, or the symbol display field 5′, and constitute merely a variant for representing the two switched states of the rear-space lighting device. The breakthrough 13 which can be lit and which is provided in the operating element 7 is provided here in place of the field 17.

The symbol display field 9′ is used for context-dependent functional display, it being possible to display the symbol “AC off” in the upper region of the symbol display field 9′ and the symbol “REST” below it, while in each case one of the two symbols is illuminated as a function of the switched state of the device, here a heating and air conditioning device, which can be switched by means of the operating element 9, and as a result the symbol can be perceived from the viewing side of the symbol display field which faces the operator, while the respective other symbol, although it is however not backlit, can be perceived from the front side of the symbol display field 9′.

The symbol display field 11′ represents an alternative to the symbol display field 9′ in which the context-dependent functional/state display is effected centrally in the symbol display field 11′ by means of a prism overlay, and in each case only the symbol which indicates the present state of the device can be perceived in the symbol display field 11′, and is also backlit.

It is to be noted that symbols of virtually any design can be displayed in the symbol display fields, and the symbols which are described with reference to FIGS. 1 and 2 are only exemplary of the design and the function of the operating and display unit 1. The described variants of symbols, switched states and lighting systems can be varied with one another as desired and are not restricted to the exemplary embodiments which are illustrated and described.

In one exemplary embodiment of the operating and display unit 1 which is not illustrated in the figures there is provision for the operating elements to be arranged with a respectively associated symbol display field in specific group formations. In this context, the plurality of operating elements and symbol display fields are arranged in a preferably right-angled matrix which has rows and columns. For example, only operating elements arranged in a first row, and the symbol display fields, which are assigned to the operating elements, arranged in a second row which is arranged underneath, while, in turn operating elements are again located in a third row and the associated symbol display fields are again located in a fourth row arranged underneath. As a result, each row is occupied either only with operating elements or only with symbol display fields, and when the matrix columns are considered each operating element is followed by a symbol display field or a symbol display field is followed by an operating element, in an alternating fashion. This type of arrangement may be advantageous in particular in restricted spatial conditions in the passenger compartment of the vehicle in order to accommodate as many operating elements and symbol display fields as possible in a very small space.

The operating and display unit 1 can also be provided with a switch-over device (not illustrated in the figures) for optionally allocating an operating element or a plurality of operating elements to a function which is assigned to a specific device, in each case the symbol which is assigned to the function which is determined by the selection of the allocation of the operating element being displayed in the symbol display field. For example, the operating elements 3 to 11 could be allocated to functions of a seat ventilating system and/or heating system by actuating the switch-over device, one or more corresponding symbols which are characteristic of a device being displayed in the respective symbol display field. Because of this configuration it is also possible to reduce the number of operating elements and symbol display fields which are necessary for a specific number of devices which are to be switched, which can provide cost advantages and enable space to be saved in the passenger compartment of the vehicle, as well as leading to improved clarity, in particular of the operating elements and symbol display fields which are arranged in groups. All the embodiment variants have in common the fact that the symbol display fields each have—in contrast to, for example, electronic displays with light emitting diodes or liquid crystal display—a fixed display, that is to say at least one permanent or invariable symbol, enabling a particularly simple, compact and cost effective design of the operating and display unit 1 to be realized.

FIG. 3 shows a cross section through the symbol display field 3′ in a schematic illustration. It is possible to see the front panel 15 which is located on the front and behind which in this exemplary embodiment there is a panel 19 with the symbols “lamp and book” and the indicated symbols 21 and 23 for the switched states “ON” and “OFF”. The symbols may be machined from the panel 19, for example lasered or punched or deep drawn, and/or printed on to it. Other embodiment variants are possible. Instead of a panel 19 it is also possible to use a correspondingly formed film or a foil or the like. It is also conceivable to provide the symbols on the rear of the front panel 15, that is to say to form them on it or attach them to it.

Behind the panel 19 a lens 25 is provided and behind this in turn a housing 27 of a lighting device is arranged, said lighting device including first and second lighting devices 29 and 31, for example LEDs. The lighting device 29 is used to light the symbol 21 located above it, and the lighting means of the symbol 23 which is arranged above it and which can be perceived only from the front side of the symbol display field 3′ if they are backlit by the corresponding lighting means. When the lighting device are not switched on, the symbols cannot be perceived, which is realized by virtue of the fact that the lens 25 is made of smoked glass which transmits to the housing 27 light which is incident from the front side of the front panel 15 but not vice versa. A separate lighting device can be assigned to the symbols “lamp and book” or they are also backlit by the respectively switched on lighting devices 29, 31.

In another exemplary embodiment in which it will be possible to perceive the symbols from the front side of the symbol display field even when the lighting device is switched off, as for example in the case of the symbol display field 9′, the lens 25 is embodied in such a way that it reflects light which is incident from the outside.

1.-11. (canceled)

12. An operating and display unit for switching devices in a motor vehicle comprising:
at least one operating element;
a symbol display field associated with each of said at least one operating element wherein the symbol display field is arranged in a fixed manner at a geometrically determined point in relation to said at least one operating element for displaying a symbol which is assigned to a device to be switched, wherein said symbol display field is embodied using black panel technology.

13. The operating and display unit as claimed in claim 12, wherein the symbol display field is backlit by at least one of search lighting and functional lighting.

14. The operating and display unit as claimed in claim 12, wherein the symbol display field has a uniformly dark appearance in a state when there is no backlighting.

15. The operating and display unit as claimed in claim 12, wherein at least one symbol of the symbol display field can be recognized or is displayed even in the state when there is no backlighting.

16. The operating and display unit as claimed in claim 12, wherein a plurality of symbols can be displayed simultaneously or successively in the symbol display field.

17. The operating and display unit as claimed in claim 12, wherein each of the at least one operating element is embodied without symbols.

18. The operating and display unit as claimed in claim 12, wherein the symbols are each displayed at a point which is the same geometrically or at points which are arranged offset with respect to each another within the symbol display field.

19. The operating and display unit as claimed in claim 12, wherein the at least one operating element is formed by a pushbutton key which is provided with a structure for improving the haptics.

20. The operating and display unit as claimed in claim 19, wherein a projected touch face of the pushbutton key is at least a quarter smaller than a projected face of the symbol display field.

21. The operating and display unit as claimed in claim 12, wherein each operating element is assigned a symbol display field the symbol display fields being arranged in series and the transition between symbol display fields which are arranged adjacent to one another is virtually invisible to the user due to an effect of the black panel.

22. The operating and display unit as claimed in claim 12, further comprising a switch-over device for optionally allocating to the at least one operating element a function which is assigned to a specific device, the function being selectable from a number of functions of a plurality of devices, wherein the symbol which is assigned to the function which is determined by the selection of the allocation of the operating element is displayed in the symbol display field.

23. The operating and display unit is claimed in claim 19, wherein said pushbutton key is a rocker key.

24. The operating and display unit as claimed in claim 20, wherein said projected touch face is more than one half smaller that the projected face of the symbol display field.

25. The operating and display unit as claimed in claim 13, wherein the symbol display field has a uniformly dark appearance in a state when there is no backlighting.

26. The operating and display unit as claimed in claim 13, wherein at least one symbol of the symbol display field can be recognized or is displayed even in the state when there is no backlighting.

27. The operating and display unit as claimed in claim 13, wherein a plurality of symbols can be displayed simultaneously or successively in the symbol display field.

28. The operating and display unit as claimed in claim 14, wherein a plurality of symbols can be displayed simultaneously or successively in the symbol display field.

29. The operating and display unit as claimed in claim 15, wherein a plurality of symbols can be displayed simultaneously or successively in the symbol display field.

30. The operating and display unit as claimed in claim 13, wherein each of the at least one operating element is embodied without symbols.

31. The operating and display unit as claimed in claim 14, wherein each of the at least one operating element is embodied without symbols.
